(19) United States
(12) Patent Application Publication
(10) Pub. No.: US 2019/0212868 A1
(43) Pub. Date: Jul. 11, 2019

(54) TACTILE SENSATION PRESENTATION DEVICE

(71) Applicant: KABUSHIKI KAISHA TOKAI RIKA DENKI SEISAKUSHO, Aichi (JP)

(72) Inventor: Takashi UENO, Aichi (JP)

(21) Appl. No.: 16/328,889

(22) PCT Filed: Aug. 3, 2017
(86) PCT No.: PCT/JP2017/028270

§ 371 Date: Feb. 27, 2019

(30) Foreign Application Priority Data
Sep. 14, 2016 (JP) 2016-179169

(51) Int. Cl. G06F 3/041; G06F 3/044; G06F 3/0354

(52) U.S. Cl. CPC G06F 3/0416; G06F 3/03547; G06F 3/044

(57) ABSTRACT

A tactile sensation presentation device includes a panel including an operation surface, an actuator configured to apply vibration to the operation surface, and a controller configured to control the actuator to apply an attenuated vibration to the operation surface such that a tactile sensation indicating an end of a function of an operation target as a state of the operation target is presented to an operator. The controller discontinuously may vibrate the operation surface. The controller may be configured to vibrate the operation surface at a certain interval, not to attenuate waveforms of vibration regarded as one lump, and to attenuate vibration to be applied to the operation surface by a tactile sensation pattern making an amplitude smaller for each solitary waveform being a lump of waveforms.

### TECHNICAL FIELD

The present invention relates to a tactile sensation presentation device.

### BACKGROUND ART

A tactile interface including an actuator and a controller configured to control tactile cells is known (e.g., Patent Document 1).

Depending on a type of desired tactile effect as well as attenuation characteristics of a system, the controller provides a short mechanical type of tactile effect, by generating a kick-in pulse to be followed by a main pulse to generate increasing acceleration response and/or by generating a brake pulse.

### CITATION LIST

### Patent Document

Patent Document 1: JP2010-287231A

### SUMMARY OF INVENTION

### Technical Problem

The tactile interface disclosed in the Patent Document 1 cannot present a state of a function of an operation target.

An object of the invention is to provide a tactile sensation presentation device that can present a state of an operation target.

### Solution to Problem

The tactile sensation presentation device according to an embodiment of the invention includes a panel including an operation surface, an actuator configured to apply vibration to the operation surface, and a controller configured to control the actuator so as to apply attenuated vibration to the operation surface and present tactile sensation indicating an end of a function of an operation target as a state of the operation target to an operator by controlling the actuator so as to apply attenuated vibration to the operation surface.

### Advantageous Effects of Invention

According to the embodiment of the invention, a tactile sensation presentation device can be provided by which a state of an operation target is presented.

### BRIEF DESCRIPTION OF DRAWINGS

FIG. 1A is a schematic diagram illustrating an interior of a vehicle in which an example of a tactile sensation presentation device according to the embodiment is installed.

FIG. 1B is a schematic diagram illustrating an example of the tactile sensation presentation device.

FIG. 1C is a block diagram illustrating an example of the tactile sensation presentation device.

FIG. 2 is graphs, wherein (a) is a graph for describing an example of a load detected by a load detection unit included in the tactile sensation presentation device according to the embodiment and a load threshold value, and (b) is a graph for describing an example of a driving signal to be outputted to an actuator.

FIG. 3A is a schematic diagram illustrating an example of an icon displayed on a display device in which a function assigned to the icon is in an end state.

FIG. 3B is a schematic diagram illustrating an example of the icon, the function of which is in a start state.

FIG. 4 is a flowchart illustrating an example of operations of the tactile sensation presentation device according to the embodiment.

### DESCRIPTION OF EMBODIMENT

### Overview of Embodiments

A tactile sensation presentation device according to the embodiment includes a panel including an operation surface, an actuator configured to apply vibration to the operation surface, and a controller configured to present tactile sensation indicating an end of a function of an operation target as a state of the operation target to an operator by controlling the actuator so as to apply attenuated vibration to the operation surface.

The tactile sensation presentation device presents the end of the function that is one of states of the operation target by applying the attenuated vibration, and thus this configuration can present the state of the operation target, compared with a case in which this configuration is not adopted.

### Embodiment

### Overview of Tactile Sensation Presentation Device 1

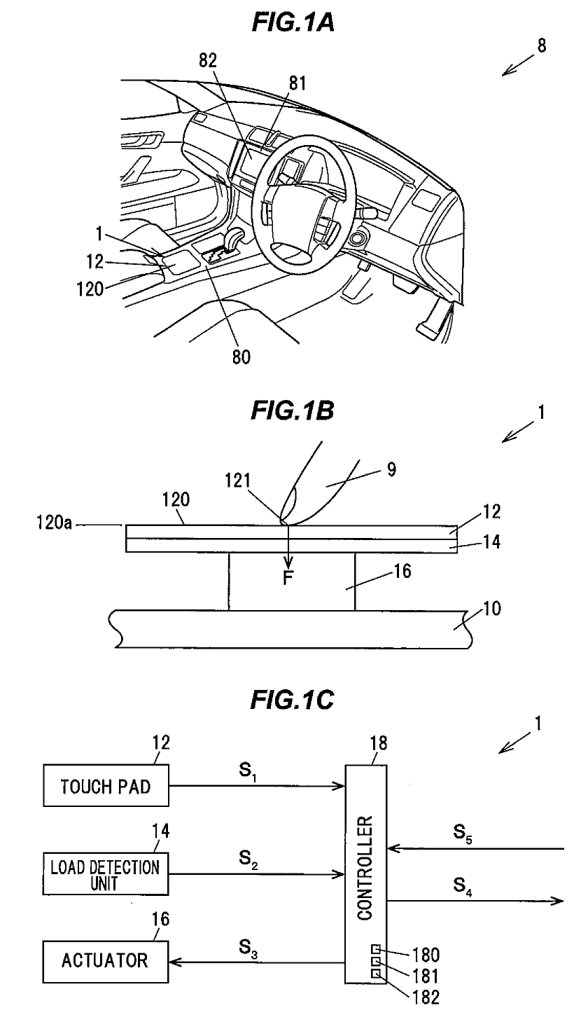

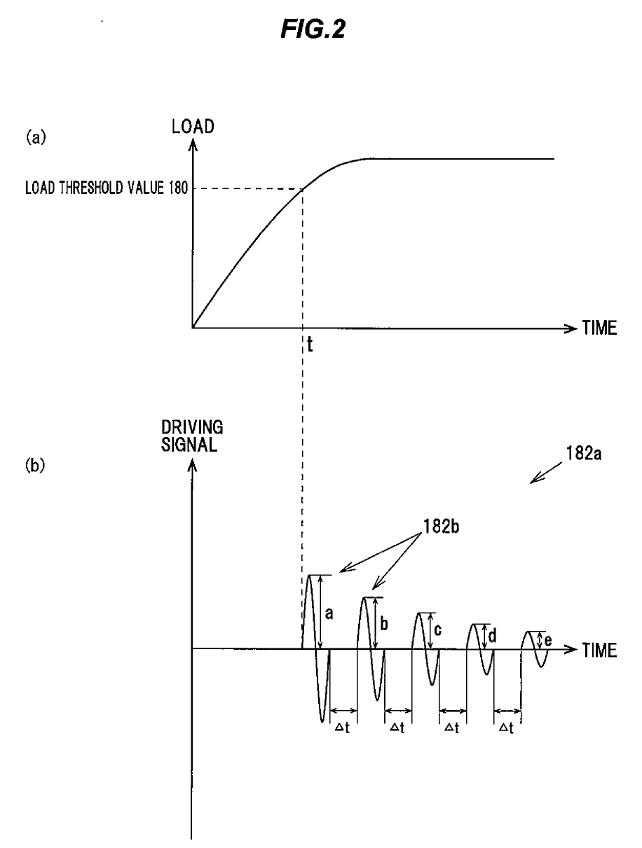

FIG. 1A is a schematic diagram illustrating an interior of a vehicle in which an example of a tactile sensation presentation device according to the embodiment is installed. FIG. 1B is a schematic diagram illustrating an example of the tactile sensation presentation device. FIG. 1C is a block diagram illustrating an example of the tactile sensation presentation device. FIG. 2(a) is a graph for describing an example of a load detected by a load detection unit included in the tactile sensation presentation device according to the embodiment and a load threshold value. FIG. 2(b) is a graph for describing an example of a driving signal to be outputted to an actuator. In FIG. 2(a), a horizontal axis denotes time and a vertical axis denotes a detected load. In FIG. 2(b), a horizontal axis denotes time and a vertical axis denotes a driving signal. Note that a load F is positive in a downward direction of the page in which FIG. 1B is illustrated.

In the drawings associated with the following embodiments, ratios between elements in the drawings may be different from the actual ratios. In addition, in FIG. 1C, arrows indicate the flows of primary signals, information, and the like. Additionally, “A to B” indicating a value range is used in the meaning of “equal to or larger than A, and equal to or smaller than B.”

A tactile sensation presentation device 1 is arranged so that an operation surface 120 is exposed on a floor console 80 in a vehicle 8, for example, as illustrated in FIG. 1A. The tactile sensation presentation device 1 is electromagnetically connected, for example, to an electronic device being an operation target mounted in the vehicle 8. Moreover, the tactile sensation presentation device 1 is a remote operation device capable of instructing movement of a cursor, selection, determination, drag, and drop of an icon, and the like, which are displayed on a display device 82 arranged on the center console 81 that is a display portion of the electronic device. An electronic device being an operation target includes, as an example, a navigation device, an air conditioning device, a music playback device, a video playback device, or the like.

Additionally, the tactile sensation presentation device 1 is configured to present tactile sensation to an operator by applying vibration to the operation surface 120 in response to an operation performed on the operation surface 120.

Specifically, the tactile sensation presentation device 1, as illustrated in FIG. 1B to FIG. 2 (b), includes a panel including the operation surface 120, an actuator 16 configured to apply vibration to the operation surface 120, and a controller 18 configured to present tactile sensation indicating an end of a function of an operation target as a state of the operation target to an operator by controlling the actuator 16 so as to apply attenuated vibration to the operation surface 120.

In addition, the tactile sensation presentation device 1 according to the embodiment includes a load detection unit 14 configured to detect the load F applied when an operation for pushing the operation surface 120 is performed. Moreover, the controller 18 presents tactile sensation by controlling the actuator 16, when the detected load F is equal to or larger than a load threshold value 181.

The tactile sensation presentation device 1, for example, when the operation surface 120 is operated to start a function of an operation target, presents tactile sensation for starting the function by applying vibration, of which amplitude is discretely gradually amplified to the operation surface 120. Additionally, the tactile sensation presentation device 1, for example, as illustrated in FIG. 2(a) and FIG. 2(b), when the operation surface 120 is operated to end the function of the operation target, presents tactile sensation for ending the function by applying attenuated vibration to the operation surface 120. That is, the tactile sensation presentation device 1 presents the tactile sensations for starting and ending the function of the operation target that indicate states of the operation target. Note that the tactile sensation presentation device 1 may be configured to present the start of the function by presenting vibrations in increasing order of the vibrations, instead of the attenuated vibration illustrated in FIG. 2(b), as an example.

The above-described panel is, for example, as illustrated in FIG. 1B, a touch pad 12 configured to detect a location of an operating finger 9 touching the operation surface 120. Note that, as a modification, the panel may be a plate member imitating a switch button.

### Configuration of Touch Pad 12

The touch pad 12 is a touch sensor that detects a touched position on the operation surface 120 when the operation surface 120 is touched by a part of the operator's body (an operating finger, for example) or with a dedicated pen, for example. The operator can, for example, operate a connected electronic device by manipulating the operation surface 120. A resistive film-type, or electrostatic capacitance-type touch panel can be used as the touch pad 12, for example. In this embodiment, the touch pad 12 is an electrostatic capacitance-type touch sensor, as an example.

The touch pad 12 is arranged under the operation surface 120 in a state where a plurality of driving electrodes and a plurality of detection electrodes cross one another while maintaining insulation. The touch pad 12, for example, scans the plurality of driving electrodes and the plurality of detection electrodes to periodically read electrostatic capacitance. The touch pad 12, based on the read electrostatic capacitance, calculates coordinates of a detection point 121 where the operating finger 9 is detected.

In addition, the touch pad 12, for example, generates detection information S1 based on the calculated coordinates of the detection point 121 to output the detection information to the controller 18. The coordinates are, for example, coordinates in a coordinate system set on the operation surface 120.

### Configuration of Load Detection Unit 14

The load detection unit 14 is arranged on a back surface side of the touch pad 12 and configured to detect the load F applied to the operation surface 120, as illustrated in FIG. 1B. As for the load F, a load applied in a pushing direction is regarded as positive, with a reference position 120a, where a load and vibration are not applied, as a reference.

The load detection unit 14 is, for example, a strain gauge. The load detection unit 14 generates load information S2 based on the detected load F to output the load information to the controller 18.

### Configuration of Actuator 16

The actuator 16 is arranged at the back surface side of the operation surface 120, as illustrated in FIG. 1B. The actuator 16 is configured by using a voice coil motor or a piezo element, for example.

The actuator 16 according to the embodiment is a voice coil motor arranged between a housing 10 and the load detection unit 14. The actuator 16, based on a driving signal S3 outputted from the controller 18, vibrates the operation surface 120 up and down with respect to the reference position 120a. The driving signal S3 that drives the operation surface 120 in an upper direction with respect to the reference position 120a is denoted at an upper side of the graph illustrated in FIG. 2(b). Additionally, the driving signal S3 that drives the operation surface 120 in a lower direction with respect to the reference position 120a is denoted at a lower side of the graph illustrated in FIG. 2(b).

### Configuration of Controller 18

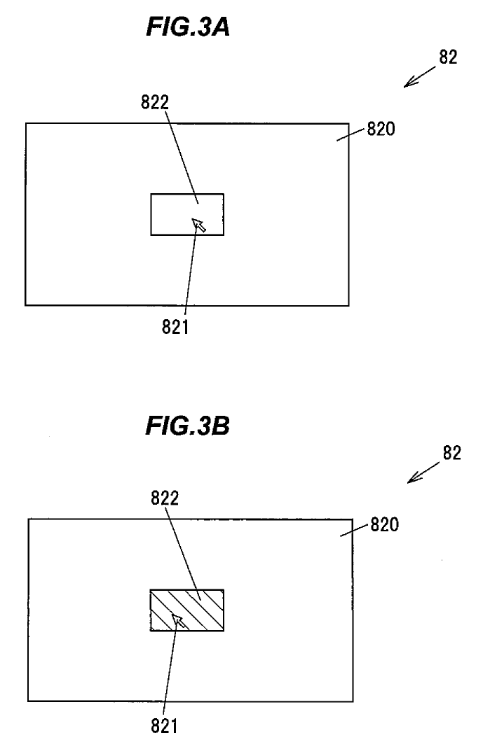

FIG. 3A is a schematic diagram illustrating an example of an icon displayed on a display device, and a function assigned to the icon is in an end state. FIG. 3B is a schematic diagram illustrating an example of the icon, the function of which is in a start state. In FIG. 3A, an icon 822 displayed on a display screen 820 is configured so that, according to selection determination by a cursor 821, a state of an assigned function of an operation target changes and the display also changes, as an example.

The controller 18 is, for example, a microcomputer including a Central Processing Unit (CPU) that carries out computations, processes, and the like on acquired data in accordance with stored programs, Random Access Memory (RAM) and Read Only Memory (ROM) that are semiconductor memories, and the like. A program for operations of the controller 18, state information 180, a load threshold value 181 and presentation pattern information 182, for example, are stored in the ROM.

Additionally, the controller 18 is configured to output, based on the detection information S1 obtained from the touch pad 12 and the load information S2 obtained from the load detection unit 14, operation information S4 including coordinate information of the detection point 121 of the operating finger 9 and information about an operation pushing the operation surface 120 (push operation), to the connected electronic device being the operation target, for example.

The state information 180 is, for example, information relating to a state of the operation target. The controller 18, for example, when the push operation is performed on the operation surface 120, determines whether the function starts or ends, based on the state information 180, to present appropriate tactile sensation. The controller 18, as an example, generates the state information 180 based on designation information S5 obtained from the operation target.

As a modification, the controller 18 may be configured to present the tactile sensation by determining whether the function of the operation target starts or ends based on the designation information S5, for example. Note that, in a case of a configuration in which the tactile sensation presentation device 1 does not include the load detection unit 14, based on the designation information S5 outputted from the operation target, the controller 18 presents the tactile sensation indicating the start of the function and the tactile sensation indicating the end of the function.

In addition, the state information 180, for example, when a plurality of icons for which each function is assigned are displayed, stores a current state of each of the plurality of icons.

The load threshold value 181 is, as illustrated in FIG. 2(a), a threshold value for determining whether to present tactile sensation or not. The controller 18, for example, as illustrated in FIG. 2(a) and FIG. 2(b), compares the detected load F with the load threshold value 181, and generates the driving signal S3 including a tactile sensation pattern 182a to output the generated driving signal to the actuator 16 when the load F is equal to or larger than the load threshold value 181 at time t. The tactile sensation pattern 182a is generated based on the presentation pattern information 182. Note that the presentation pattern information 182 may be a mathematical function, for example.

The tactile sensation pattern 182a for presenting the end of the function is a pattern for discontinuously vibrating the operation surface 120, as illustrated in FIG. 2(b). In addition, the tactile sensation pattern 182a is a pattern for vibrating the operation surface 120 at a certain time interval Δt. That is, the tactile sensation pattern 182a, in which a plurality of solitary waveforms 182b are arranged at the certain time interval Δt, and an amplitude of the solitary waveform 182b is not attenuated, and moreover the amplitude of the solitary waveform 182b following one solitary waveform 182b in time becomes smaller than the one solitary waveform 182b, is an attenuated pattern as a whole. The solitary waveform 182b is, as an example, a sine wave. Note that the waveform is not limited to the sine wave, and may be various waveforms such as a rectangular wave, and a triangular wave.

The controller 18 is, as described above, configured to vibrate the operation surface 120 at the certain time interval Δt, not to attenuate waveforms of vibration regarded as one lump, and to attenuate vibration to be applied to the operation surface 120 by making the amplitude smaller for each lump of waveforms. The controller 18 reminds the operator of sensation of which vibration gradually fades away, by discretely attenuated vibration.

When the solitary waveform 182 is the sine wave, according to a result of an experiment or the like, the tactile sensation pattern 182a is configured as a combination pattern of a frequency f of 10 to 100 Hz, a wave period included in the solitary waveform 182b of 0.5 to 2 periods, the time interval Δt of 0.05 to 0.2 s, an attenuation ratio ζ of 0.1 to 0.9, and a wave number of 2 to 7 waves.

Specifically, when the frequency f is lower than 10 Hz, perception via tactile sensation is difficult. Additionally, when the frequency f is higher than 100 Hz, because tactile sensation for each vibration is clear, it is difficult to remind the operator of sensation of gradual attenuation.

When a wave included in the solitary waveform 182b is shorter than 0.5 period, because vibration to be perceived is weak, it is difficult to remind the operator of sensation of gradual attenuation. In addition, when a wave included in the solitary waveform 182b is longer than 2 periods, because a tactile sense is deteriorated, the wave is inappropriate.

When the time interval Δt is shorter than 0.05 s, because the time interval between the solitary waveforms 182b becomes shorter, it is difficult to perceive a plurality of waves. Additionally, when the time interval Δt is longer than 0.2 s, because the time interval is too long, the operator cannot feel a tactile sense of gradual attenuation.

When the attenuation ratio ζ is smaller than 0.1, because the first waveform is emphasized, only one wave is perceived, a tactile sense becomes like click feeling in the prior art, and thus the attenuation ratio is inappropriate. Moreover, the attenuation ratio ζ is larger than 0.9, the operator cannot feel tactile sensation of gradual attenuation.

When a wave number is one wave, simple vibratory feedback is provided like the click feeling in the prior art. In addition, when a wave number is equal to or more than eight waves, because duration time of vibration becomes longer, a tactile sense is deteriorated, and thus the wave number is inappropriate.

According to the above result, optimum conditions for the tactile sensation pattern 182a is, as an example, configured as a combination pattern of the frequency f of Hz, the wave period included in the solitary waveform 182b of 1 period, the time interval Δt of 0.1 s, the attenuation ratio ζ of 0.7, and the wave number of 5 waves. Note that, as illustrated in FIG. 2(b), the attenuation ratio ζ is b/a=c/b=d/c=e/d. In FIG. 2(b), the attenuation ratio ζ of the solitary waveform 182b is 0.7.

The controller 18, when the function of the operation target ends, as illustrated in FIG. 2(b), generates the driving signal S3 including the gradually attenuated tactile sensation pattern 182a to output the generated driving signal to the actuator 16. Moreover, the controller 18, when the function of the operation target starts, as an example, generates the driving signal S3 including a tactile sensation pattern in which vibration seems to be gradually amplified, that is, in which the tactile sensation pattern 182a is reversed, to output the generated driving signal to the actuator 16. Note that the tactile sensation pattern at the start of the function may be continuous vibration having a constant amplitude, for example.

The controller 18, for example, as illustrated in FIG. 3A, in a case in which the function of the icon 822 is in an end state, when a push operation is performed on the operation surface 120 in a state in which the icon 822 is selected by the cursor 821, generates the driving signal S3 for presenting a start state of the function based on the presentation pattern information 182, and outputs the generated driving signal to the actuator 16 to present the start of the function.

In addition, the controller 18, for example, as illustrated in FIG. 3B, when a push operation is performed on the operation surface 120 in a state in which the icon 822, the function of which, has started is selected by the cursor 821, generates the driving signal S3 for presenting the end of the function based on the presentation pattern information 182, and outputs the generated driving signal to the actuator 16 to present the end of the function.

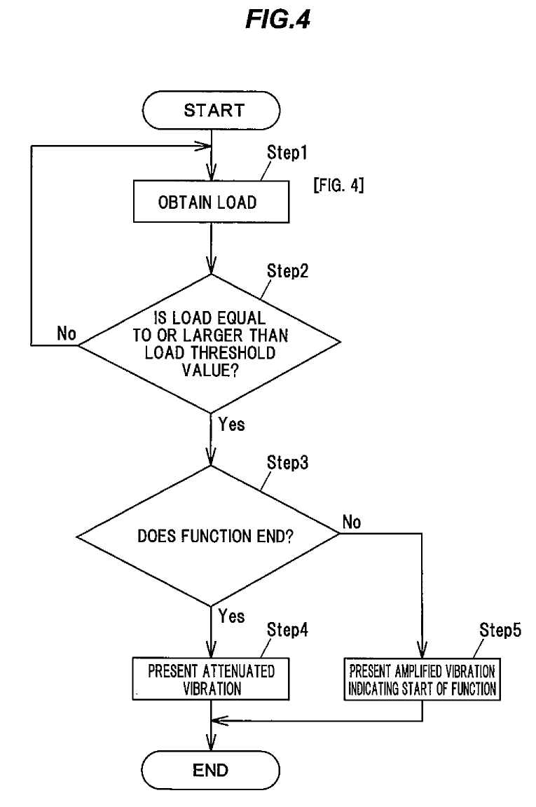

Hereinafter, an example of the operation of the tactile sensation presentation device 1 according to the embodiment will be described, in accordance with the flowchart of FIG. 4. Here, a case will be described in which a first tactile sensation and a second tactile sensation are presented by pushing the operation surface 120.

### Operation

The controller 18 included in the tactile sensation presentation device 1 obtains the load information S2 from the load detection unit 14 (Step 1) to monitor whether the obtained load information exceeds the load threshold value 181. The controller 18, when “Yes” is established in Step 2, that is, when the detected load F is equal to or larger than the load threshold value 181 (Step 2: Yes), refers to the state information 180 to check whether a state of the operation target is the start or the end of the function.

The controller 18, when the function ends (Step 3: Yes), generates the driving signal S3, for which vibration is discretely gradually attenuated, to output the generated driving signal to the actuator 16, and presents attenuated vibration (Step 4).

Specifically, the controller 18 generates the driving signal S3 according to the discretely gradually attenuated tactile sensation pattern 182a based on the presentation pattern information 182 to output the generated driving signal to the actuator 16. The controller 18 presents the tactile sensation indicating the end of the function by vibrating the actuator 16 so that vibration to be applied to the operation surface 120 is discretely gradually attenuated based on the driving signal S3, and finishes the operation.

Here, in Step 3, the controller 18, when the function starts (Step 3: No), generates the driving signal S3 for which vibration is discretely gradually amplified to output the generated driving signal to the actuator 16, and presents the amplified vibration (Step 5). Here, in Step 3, the controller 18.

Specifically, the controller 18 generates the driving signal S3 so as to be discretely gradually attenuated, which seems to be the reversed tactile sensation pattern 182a, based on the presentation pattern information 182, to output the generated driving signal to the actuator 16. The controller 18 presents the tactile sensation indicating the start of the function by vibrating the actuator 16 so that vibration to be applied to the operation surface 120 is discretely gradually amplified based on the driving signal S3, and finishes the operation.

### Effect of Embodiments

The tactile sensation presentation device 1 according to the embodiment can present a state of an operation target. Specifically, the tactile sensation presentation device 1, when a function of an operation target ends by an operation pushing the operation surface 120, because discretely attenuated vibration that is clearly different from continuous vibration, vibrates the operation surface 120, compared with a case in which this configuration is not adopted, a state of the operation target in which the function ends can be presented to an operator by tactile sensation.

In the tactile sensation presentation device 1, because vibration is not continuously attenuated, the solitary waveform 182b that is a lump of waveforms is presented at the certain time interval Δt, and the solitary waveform 182b following one solitary waveform 182b in time becomes smaller than the one solitary waveform 182b, and thus the vibration is attenuated as a whole. Accordingly, compared with a case in which this configuration is not adopted, an operator can easily recognize attenuation.

Moreover, the tactile sensation presentation device 1 can present tactile sensation when a function of an operation target switches from a first state to a second state, or from the second state to the first state by a pushing operation.

Although several embodiments of the invention and modifications thereof have been described above, these embodiments and modifications are merely examples, and the invention according to claims is not intended to be limited thereto. Such novel embodiments and a modified example can be implemented in various other forms, and various omissions, substitutions, changes, and the like can be made without departing from the spirit and scope of the invention. In addition, all combinations of the features described in these embodiments and modified example are not necessarily essential to solve the problem of the invention. Furthermore, these embodiments and modifications are included within the spirit and scope of the invention and also within the scope of the invention described in the claims and equivalents thereof.

### REFERENCE SIGNS LIST

1 Tactile sensation presentation device

14 Load detection unit

16 Actuator

18 Controller

120 Operation surface

182a Tactile sensation pattern

182b Solitary waveform

1. A tactile sensation presentation device, comprising:
a panel including an operation surface;
an actuator configured to apply vibration to the operation surface; and
a controller configured to control the actuator to apply an attenuated vibration to the operation surface such that a tactile sensation indicating an end of a function of an operation target as a state of the operation target is presented to an operator.

2. The tactile sensation presentation device according to claim 1, wherein the controller discontinuously vibrates the operation surface.

3. The tactile sensation presentation device according to claim 2, wherein the controller is configured to vibrate the operation surface at a certain interval, not to attenuate waveforms of vibration regarded as one lump, and to attenuate vibration to be applied to the operation surface by a tactile sensation pattern making an amplitude smaller for each solitary waveform being a lump of waveforms.

4. The tactile sensation presentation device according to claim 1, further comprising a load detection unit configured to detect a load applied when an operation for pushing the operation surface is performed,
wherein the controller is configured to present the tactile sensation for indicating an end of a function of the operation target by controlling the actuator if the detected load is not less than a load threshold value.

5. The tactile sensation presentation device according to claim 3, wherein the solitary waveform comprises a sine wave, a rectangular wave, or a triangular wave.

6. The tactile sensation presentation device according to claim 5, wherein if the solitary waveform is the sine wave, the tactile sensation pattern is configured as a combination pattern of a frequency f of 10 to 100 Hz, a wave period included in the solitary waveform of 0.5 to 2 periods, a time interval Δt of 0.05 to 0.2 s, an attenuation ratio ζ of 0.1 to 0.9, and a wave number of 2 to 7 waves.

7. A tactile sensation presentation device, comprising:
a panel including an operation surface;
an actuator configured to apply vibration to the operation surface; and
a controller configured to control the actuator to apply an amplified vibration to the operation surface such that a tactile sensation indicating a start of a function of an operation target as a state of the operation target is presented to an operator.

8. The tactile sensation presentation device according to claim 7, wherein the controller is configured to vibrate the operation surface at a certain interval, not to amplify waveforms of vibration regarded as one lump, and to amplify vibration to be applied to the operation surface by a tactile sensation pattern making an amplitude larger for each solitary waveform being a lump of waveforms.
